(19) United States
(12) Patent Application Publication
(10) Pub. No.: US 2013/0343075 A1
(43) Pub. Date: Dec. 26, 2013

(54) VEHICLE LAMP

(71) Applicant: Automotive Lighting Reutlingen GmbH, Reutlingen (DE)

(72) Inventors: Marc Schirmer, Attenweiler (DE); Hermann Kellermann, Reutlingen (DE)

(21) Appl. No.: 13/905,759

(22) Filed: May 30, 2013

(30) Foreign Application Priority Data
Jun. 20, 2012 (DE) 10 2012 210 444.5

(51) Int. Cl. F21S 8/10

(52) U.S. Cl. CPC F21S 48/234
USPC 362/516

(57) ABSTRACT

A vehicle lamp comprises a housing with at least one mirrored mirror surface arranged in the housing and a light source that can be arranged in the housing. It is possible to radiate light emitted from the light source under operating conditions in a main beam direction. At least one deflection body is arranged in the mirrored mirror surface such that light impinging the deflection body can be reflected and/or deflected from the deflection body in a secondary beam direction that cannot directly be illuminated by the light source. The deflection body is adjusted to a three-dimensional surface of the mirrored mirror surface such that the three-dimensional surface is maintained at least in sections such that light can be deflected in the main beam direction and secondary beam direction through the deflection body.

### CROSS-REFERENCE TO RELATED APPLICATION

This application is based upon and claims priority to German Patent Application 10 2012 210 444.5 filed on Jun. 20, 2012.

### BACKGROUND OF INVENTION

1. Field of Invention

The invention relates to, in general, a lamp and, in particular, a vehicle lamp comprising a housing with at least one mirrored mirror surface arranged in the housing and a light source that can be arranged in the housing, wherein it is possible to radiate light emitted from the light source under operating conditions in a main beam direction and at least one deflection body is arranged in the mirrored mirror surface such that light impinging the deflection body can be reflected and/or deflected from the deflection body in a secondary beam direction that cannot directly be illuminated by the light source.

2. Description of Related Art

Such vehicle lamps are well known from the related art. Certain law has specific requirements on the visibility of the light function. Signal lamps provided on the vehicle (for example, navigation lights or indicator lights) have to meet certain minimum requirements that may not be reduced as well as maximum values that may not be exceeded. In the process, the light distribution is divided (for example, horizontally into as range of between −20° and +20° and vertically of between −10° and +10°. In this range, photometric, values are established at specific measuring points, whereupon the light has to be distributed evenly. At a range of visibility of 45° to the center of the vehicle and 80° to the exterior of the vehicle or vertically of between −15° and +15°, specific minimum values may not be reduced, and specific maximum values may not be exceeded.

In addition, there are the so-called “side markers” that represent an independent light or signal function. At the same time, a distinction can be made between the so-called “passive side marker,” which usually is a yellow retro-reflector, and the “active side marker.” The active side marker represents also a light function in which yellow light radiates sideways. Such active side markers are usually produced with a freely illuminating light source without reflector. However, it is also possible to implement the active side marker (for example, through the dimmed light source of the indicator lamp) to save a light source. The light color of such a light source is also specified. To implement the “side marker” function, provision can be made to operate the yellow LEDs of the indicator lamps with reduced power because they don't change their light color. However, it is also possible to use a two-filament bulb in which the main coil serves as light source (for example, for the indicator lamp), and the secondary coil can be used as light source for the active side marker.

However, these legal requirements are conflicting with the requirements of the market or the clients and the design concepts of the designers. In newer motor vehicles, vehicle lamps are increasingly used to design the face of the vehicle by these lamps. Also, because of the vehicle contour, the shape of vehicle lamps is becoming more and more extreme. As a result, the light emitted from the light source under operating conditions cannot necessarily reach the legally required areas. In fact, the related art has disclosed several possible solutions for deflecting the light in the specified areas.

On the one hand, provision can be made to arrange structures in the vehicle lamp that deflect the light in specific directions to increase visibility in vehicle direction. For example, it is a well-known method to arrange inside a vehicle headlamp reflecting elements at the edge of the reflector surface or on surfaces adjoining the reflector surface (i.e., prism or pyramid-shaped reflecting structures). It is also possible to solve the problem by dulling the cover frame of the headlamp. Other proposals involve providing in the cover plate or glass panel of a vehicle lamp additional refractive elements, which deflect light in the specified areas.

For example, to implement the active side markers, a gap or recess can be provided in the reflector of the vehicle lamp so that a secondary coil or a dimmed main coil of a light source of the vehicle lamp is visible from the side of the vehicle. To implement the active side marker, it is also possible to provide deflection mirrors inside the vehicle lamp. Furthermore, a well-known method involves attaching reflectors (for example, reflecting cube corners or prisms) on cover frames or tube surfaces inside a vehicle lamp to deflect light in the legally specified areas.

For example, DE 198 23 106 B4 discloses the method of providing in a vehicle lamp reflecting sections equipped with vertical stripe stages, thus forming a stepped reflecting surface that reflects part of the light to the back in relation to the vehicle body.

However, with the solution options known from the related art, it is not necessarily possible to specifically deflect light in all the required areas. This is especially due to the fact that the headlamps or vehicle lamps have a very compact design. Furthermore, the assembly units arranged within a headlight are becoming increasingly larger. This applies especially to LED-assembly units. As a result, stepped reflecting surfaces known, for example, from DE 198 23 106 B4 can no longer be provided because the vehicle does not offer enough space. Moreover, due to lack of space or because of undefined deflection of light, an installation of reflectors or deflection mirrors is not desirable.

In many cases, the extreme geometry of the vehicle lamps leaves them with a pronounced sweep. In this context, the sweep involves the angle of the vehicle lamp or vehicle headlight in relation to the longitudinal axis of the vehicle. Because of the sweep, it is not necessarily possible to deflect light in the legally specified areas.

Therefore, the invention is based on the objective of providing a lamp (in particular, a vehicle lamp), wherein light should be deflected in the legally specified areas despite a limited amount of space and it should be easy to produce the vehicle lamp.

### SUMMARY OF INVENTION

The invention overcomes problems in the related art in a vehicle lamp comprising a housing with at least one mirrored mirror surface arranged in the housing and a light source that is arranged in the housing. It is possible to radiate light emitted from the light source under operating conditions in a main beam direction. At least one deflection body is arranged in the mirrored mirror surface such that light impinging the deflection body can be reflected and/or deflected from the deflection body in a secondary beam direction that cannot directly be illuminated by the light source. The deflection body is adjusted to a three-dimensional surface of the mirrored mirror surface such that the three-dimensional surface is maintained at least in sections such that light can be deflected in the main beam direction and secondary beam direction through the deflection body.

Accordingly, provision has been made that the at least one deflection body is adjusted to a three-dimensional surface of the mirrored mirror surface such that the three-dimensional surface of the mirrored mirror surface is maintained at least in sections such that light can be deflected in the main beam direction and that light can be deflected in the secondary beam direction through the at least one deflection body.

Compared to the related art, this is especially advantageous in that, from specific angular ranges in front of the vehicle or on its side, only a particular area or surface of the mirrored mirror surface is visible. Consequently, only this particular surface or area can be used to deflect light in these angular ranges. Furthermore, in contrast to the related art, it is not necessarily required to provide large (for example, stepped) reflecting surfaces in the interior of the vehicle lamp. It is also not necessary to provide additional structures in the cover plate or glass panel. Advantageously, in its cross-section, the deflection body can be structured like a prism. At the same time, the cross-section can be square, rectangular, circular, etc.

In an embodiment, at least sections of the three-dimensional surface in the area of the deflection body form a continuous progression. In this way, the continuous progression of the three-dimensional surface is not disrupted by the deflection bodies, and light can continue to be deflected in the main beam direction.

An advantageous design of the lamp provides that the deflection body has a groove-like recess in the mirrored mirror surface. For example, the groove-like recesses can be impressed in the mirrored mirror surfaces. However, it is also possible to produce the groove-like recess as part of an injection-molding process i.e., when producing, for example, a reflector prior to the sputtering process (i.e., the production of the mirrored mirror surface).

A further advantageous design of the lamp provides that the deflection body defines a web-like elevation in the mirrored mirror surface. At the same time, provision can be made that the deflection body extends upward from the three-dimensional surface of the mirrored mirror surface (i.e., in the direction facing away from the mirrored mirror surface). Provision can also be made that the deflection body is produced as part of an injection-molding process, wherein, following the injection-molding process, for example, a reflector blank can be sputtered with a reflecting material. However, it is also possible to provide a reflector with the deflection bodies as part of an aluminum die-casting process.

Advantageously, the mirrored mirror surface defines a reflector wall of the lamp. At the same time, the deflection body can be arranged directly on the reflector base or in the side wall of a reflector of a vehicle lamp. In particular, it is possible to use the areas of the reflector wall or the reflector base for setting up the deflection body, which are visible from the legally specified angular ranges (i.e., from an external side of the vehicle or from the front of the vehicle). This is especially advantageous because it is not required to provide or arrange reflecting structures in the vehicle lamp for deflecting the light in the specified ranges.

Furthermore, it is advantageous when the mirrored mirror surface defines a cover element of the lamp. This is especially advantageous because, for implementing the “side marker” function (i.e., for providing visibility from an external side of the vehicle), light can be deflected toward the external side of the vehicle h arranging the deflection body on a mirrored cover element. In this context, it is especially advantageous when light can be deflected through a gap and/or recess in the cover frame of the vehicle lamp. As a result, it is possible to implement a “side marker” function even when, for example, the main and/or secondary coil of the vehicle lamp are/is not directly visible through the gap and/or recess in the cover frame of the vehicle lamp.

A further embodiment of the lamp provides that the mirrored mirror surface defines a tube surface of the lamp.

An embodiment of the lamp makes provision that light from the deflection body is deflected through an opening in a cover element of the lamp. This is advantageous because, to implement the “side marker” function or to implement the requirement of visibility from the external side of the vehicle, light can be deflected from the deflection surface arranged on the at least one mirrored mirror surface through the opening in the legally specified angular ranges.

Advantageously, the longitudinal extension of the deflection body defines a straight- and/or bent-curve progression and/or a curve progression following a predetermined curve. Consequently, by selecting an appropriate curve progression, light can be deflected in defined manner for implementing the requirements of visibility or implementing the “side marker” function. For example, in particular vehicles and/or vehicle-lamp geometries, it can be required to provide the longitudinal extension of the deflection body with a straight progression whereas, in other geometries, it can be required to provide a particular curve progression.

Furthermore, it is advantageous when, along its longitudinal extension, the deflection body defines a differing height profile. The height profile can be adjusted in an advantageous manner also to the requirements of visibility or the requirements of the “side marker” function.

A further advantageous embodiment of the lamp provides that, parallel with its longitudinal extension, the deflection body is inclined at an angle “β” across from a plane running vertically to the surface of the mirrored mirror surface. Advantageously, the angle can be selected such that the deflection body is inclined such that light along a specified direction can be deflected in the secondary beam direction.

At the same time, it is especially advantageous when the deflection body is inclined at an annular range “β” of in an embodiment, between 0° and 45° [more specifically, between 0° and 30° (and, even more specifically, between 0° and 15°)].

Advantageously, the deflection body extends vertically to the surface of the mirrored mirror surface.

Advantageously, light can be deflected horizontally at an angular range of between 45° forward and 30° backward in relation to a plane situated vertically to a longitudinal axis of the vehicle and running through the lamp, and/or light can be deflected vertically at an angular range of between 10° upward and 10° downward in relation to a horizontal plane running through the lamp. In this way it can be guaranteed that light emitted from the vehicle lamp under operating conditions can be also deflected in the legally specified areas to implement the “side marker” function.

Furthermore, it is advantageous when light can be reflected horizontally at an angular range of between 45° to the interior of the vehicle and 80′ to the exterior of the vehicle in relation to a plane running parallel to the longitudinal axis of the vehicle and vertically through the lamp and/or when light can be reflected vertically at an angular range of between 15° upward and 15° downward in relation to a plane running horizontally through the lamp. In this way, it can be guaranteed that the legal requirements for increasing, the visibility in driving direction can be fulfilled.

Other objects, features, and advantages of the vehicle lamp of the invention are readily appreciated as the vehicle lamp becomes more understood while the subsequent detailed description of at least one embodiment of the vehicle lamp is read taken in conjunction with the accompanying drawing thereof.

### BRIEF DESCRIPTION OF EACH FIGURE OF DRAWING OF INVENTION

FIG. 1 is a section of the front view of a reflector of an embodiment of a vehicle lamp of the invention;

FIG. 2 is an enlarged section of a reflector of the vehicle lamp shown in FIG. 1;

FIG. 3 is an isometric view of the reflector of the vehicle lamp shown in FIG. 1;

FIG. 4 is a sectional representation of an embodiment of deflection bodies of the vehicle lamp shown in FIG. 1;

FIG. 5 is a sectional representation of another embodiment of the deflection bodies;

FIG. 6 is a top view of a reflector of the vehicle lamp (in particular, an indicator light for implementing a “side marker” function); and

FIG. 7 is a side view of the reflector shown in FIG. 6.

### DETAILED DESCRIPTION OF EMBODIMENTS OF INVENTION

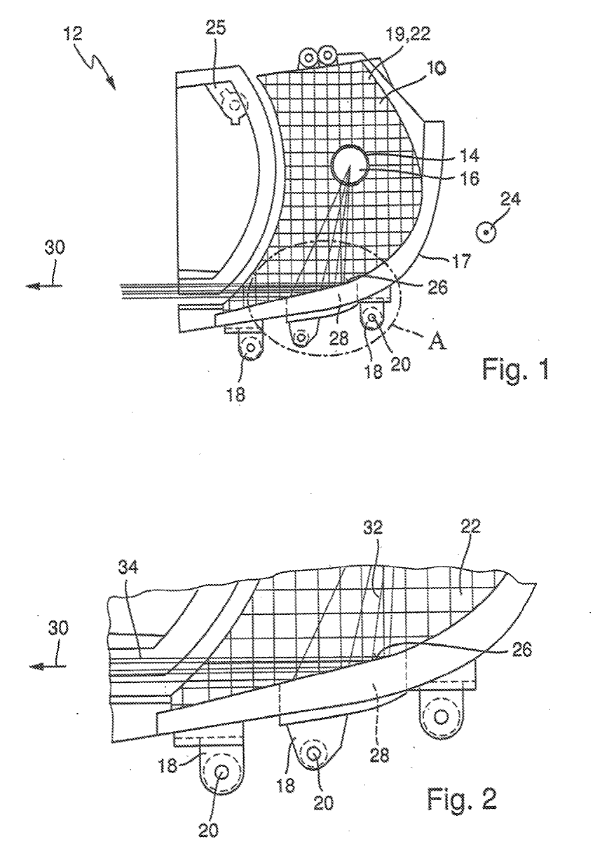

FIG. 1 shows the front view of a reflector 10 of a vehicle lamp 12. In the reflector 10, an opening 14 has been provided for accepting, a light source 16 arranged in the opening 14. On the reflector edge 17, mounting sections 18 with drill holes 20 have been provided for attaching the reflector 10 in the vehicle lamp 12 designed as a signal lamp. The reflector 10 of the vehicle lamp 12 defines a reflecting surface 19. On the one hand, the reflector 10 can be manufactured from plastic material and, in a subsequent production step, for example, be sputtered with a metal, thus producing a mirrored mirror surface 22. However, it is also possible to provide the reflector 10 with its mirrored mirror surface 22 by an aluminum die-casting process and subsequent varnishing, and sputtering of the varnished reflector. Under operating conditions of the vehicle lamp 12 (i.e., at night, in bad weather conditions, or even when used as a daytime-running light), light emitted by the light source 16 is reflected at the reflector 10 in main beam direction 24, which runs vertically to “leaf” level (indicated by an arrow). In the process, the light has to be deflected to areas in front of the vehicle predetermined by law to attain visibility or in areas sideways next to the vehicle. Because of the increasingly extreme vehicle geometries and, in many cases, complicated requirements designers place on the developers of vehicle lamps, it is not always possible to deflect light directly in the areas required by law.

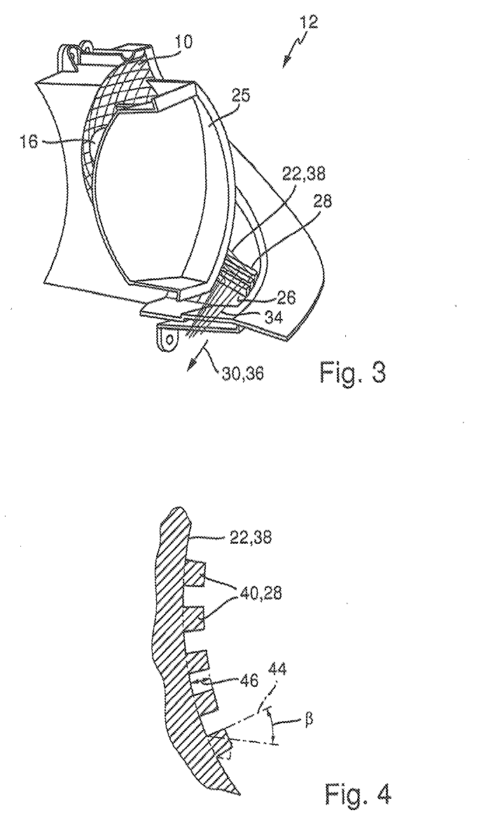

For deflecting light in areas in front of or next to a vehicle (not shown in FIG. 1) [in particular, areas that cannot directly be illuminated in the main beam direction 24 of the vehicle lamp 12 or reflector 10 because of obstacles blocking the beam path (for example, a housing of the vehicle lamp or a vehicle fender or even a further reflector displayed in FIGS. 1 and 3)], deflection bodies 28 designed as grooves have now been provided in a reflector base 26 of the reflector 10. The deflection bodies 28 deflect light emitted by the light source 16 and impinging the deflection bodies 28 in a secondary beam direction 30, which illuminates also areas next to or in front of the vehicle, but cannot be directly illuminated by the main beam direction 24 of the light.

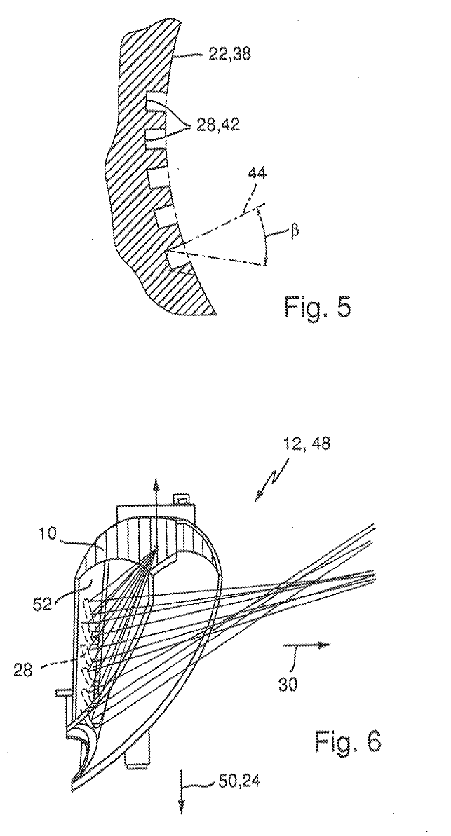

FIG. 2 shows an enlargement of the circular segment “A” shown in FIG. 1. There, deflection bodies 28 are present in the reflector base 26 of the reflector 10. Potential embodiments of the deflection bodies 28 are shown in FIGS. 4 and 5 and are described below. Light emitted forward under operating conditions by the light source 16 is reflected at the deflection bodies in the reflector base 26 of the reflector 10 and deflected in the secondary beam direction 30. Depending on the concrete design of the deflection bodies 28, incident light beams 32 are deflected such that, with the reflected light beams 34, areas are illuminated that cannot be directly illuminated by the main beam direction 24 of the vehicle lamp 12 or the reflector 10.

In an embodiment, the deflection bodies 28 are arranged only at the mirrored mirror surfaces 22 of the vehicle lamp 12, which are also visible in the vehicle lamp 12 from the respective direction in front of or next to the vehicle. For example, such a case is demonstrated in FIG. 3 by showing a side view of the reflector 10 of the vehicle lamp 12. There, a large portion of reflector 10 is covered by reflector 25. Therefore, light emitted by the light source 16 is deflected at the deflection bodies 28 in a secondary beam direction 30. FIG. 3 shows a view precisely from the secondary beam direction 30. Moreover, FIG. 3 clearly shows that the area displayed in FIG. 3 is not being illuminated by the main beam direction 24 of the reflector 10 or the vehicle lamp 12. Deflected reflected light beams 34 are deflected along the arrow 36 in the secondary beam direction 30. By arranging the deflection bodies 28 in areas like, for example, the reflector base 26 (which are visible from the areas outside of the vehicle not directly illuminated by the main beam direction 24), light can be deflected in a defined manner in areas not directly illuminated by the main beam direction 24 when the deflection bodies 28 are provided with a specific geometric structure.

At the same time, the deflection bodies are arranged in the mirrored mirror surface 22 (for example, of a reflector) or adjusted to the three-dimensional surface 38 such that the three-dimensional surface 38 of the mirrored mirror surface 22 is maintained in least in sections such that it remains possible to deflect light in the main beam direction 24 and that light can be deflected in the secondary beam direction by the deflection bodies 28.

In FIG. 4, the deflection bodies 28 are designed as web-like elevations 40. At the same time, the web-like elevations or the deflection bodies 28 are arranged on the mirror surface 22 such that it remains possible, at the three-dimensional surface 38 of the mirror surface 22, to deflect light also in a main beam direction 24. In the process, the three-dimensional surface 38 forms a continuous progression and is not disrupted by the deflection bodies 28 or the web-like elevation. In FIG. 4, the progression of the three-dimensional surface 38 is represented by a dotted line.

However, instead of the web-like elevations 40 shown in FIG. 4, it is also possible to design the deflection bodies 28 as groove-like recesses, as shown in FIG. 5. Here also, the deflection bodies 28 designed as groove-like recesses 42 are imbedded in the three-dimensional surface 38 of the mirror surface 22 such that a continuous progression of the three-dimensional surface 38 is maintained. In FIG. 5, the progression is represented by a dotted line. As a result, it is possible by the deflection bodies 28 to deflect incident light beams 32 in a secondary beam direction.

FIGS. 4 and 5 show a cross-section of the deflection body transverse to its longitudinal extension. As shown by the dotted line in FIGS. 4 and 5, it is also possible that the deflection bodies 28 are inclined at an angle “β” across from a plane 44 running vertically to the three-dimensional surface 38 of the mirrored mirror surface 22. However, it is also possible that the deflection bodies 28 extend vertically to the three-dimensional surface 38 of the mirrored mirror surface 22. Along the longitudinal extension of the deflection bodies 28, the web-like elevations 40, or the groove-like recesses 42, it is also possible to provide the deflection bodies 28, 40, 42 with a differing height profile, which means that, at the beginning of the longitudinal extension, the extension bodies 28, 40, 42 have a height (i.e., a distance 46 from the three-dimensional surface 38) that differs from any other section of the longitudinal extension. As shown in FIG. 6, for example, it is also possible that, in their longitudinal extension, the deflection bodies 28, 40, 42 define a bent-curve progression or a curve progression following a predetermined curve. However, it is also possible that the deflection bodies define a straight longitudinal extension. This results in the fact that different structures (in fact, any structure of the deflection bodies) allow light to be deflected in areas not illuminated by the main beam direction 24 or to be deflected in secondary beam direction 30.

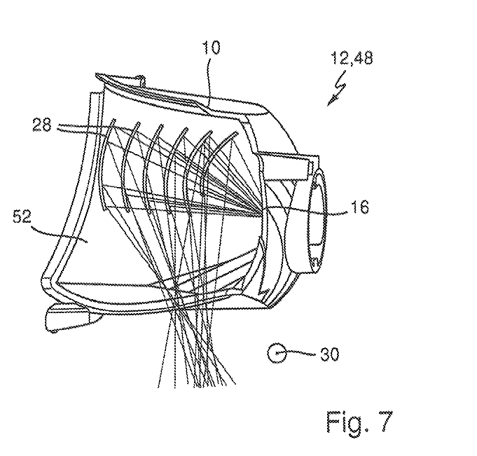

FIGS. 1 to 3 show an embodiment of a vehicle lamp 12 or a reflector 10 that provides increased visibility (i.e., light is deflected to the front of the vehicle). FIGS. 6 and 7, on the other hand, show a reflector of an indicator light 48 by which, at the same time, the “side marker” function is implemented. FIG. 6 shows a top view of a reflector 10 of a vehicle lamp 12 or an indicator light 48. The indicator light 48 uses a flash signal to show the driving direction of turning direction. The top view shows the driving direction (i.e., arrow 50 indicates a direction to the front of the vehicle). Light emitted by the light source 16 of the indicator light 48 is primarily radiated in a main beam direction 24 (i.e., along the arrow). However, transverse to the vehicle direction or the arrow 50, it is also possible by the deflection bodies 38 to deflect light in the secondary beam direction 30. In an embodiment, the light can be deflected to the outside through an opening in a cover element of the indicator light 48 (not shown in FIG. 6). The top view of FIG. 6 shows that the deflection bodies 28 define a bent-curve progression.

The lateral view of FIG. 7 provides a clearer view of the curve progression of the longitudinal extension of the deflection bodies 28. According to FIG. 7, the deflection bodies 28 are arranged in the indicator light 48 at a side wall 52 of the indicator light 48. Light emitted by the light source 16 is deflected at the deflection bodies 28 such that it is deflected under operating conditions of the indicator light in the secondary beam direction 30 (i.e., in FIG. 7 from “leaf” level). Consequently, when arranging the deflection bodies 28 at the side wall 52 of the indicator light 48, it is possible to implement the legal requirement of “side marker” function (i.e., visibility from the side of the vehicle).

It should be appreciated by those having ordinary skill in the related art that the vehicle lamp has been described above in an illustrative manner. It should be so appreciated also that the terminology that has been used above is intended to be in the nature of words of description rather than of limitation. It should be so appreciated also that many modifications and variations of the vehicle lamp are possible in light of the above teachings. It should be so appreciated also that, within the scope of the appended claims, the vehicle may be practiced other than as specifically described above.

What is claimed is:

1. A lamp of a vehicle (12, 48), the vehicle lamp comprising:
a housing with at least one mirrored mirror surface (22) arranged in the housing; and
a light source (16) that is arranged in the housing, wherein it is possible to radiate light emitted from the light source (16) under operating conditions in a main beam direction (24), at least one deflection body (28) is arranged in the mirrored mirror surface (22) such that light impinging the deflection body (28) can be at least one of reflected and deflected from the deflection body (28) in a secondary beam direction (30) that cannot directly be illuminated by the light source (16), and the deflection body (28) is adjusted to a three-dimensional surface (38) of the mirrored mirror surface (22) such that the three-dimensional surface (38) is maintained at least in sections such that light can be deflected in the main beam direction (24) and secondary beam direction (30) through the deflection body (28).

2. A vehicle lamp (12, 48) according to claim 1, wherein sections of the three-dimensional surface (38) in an area of the deflection body (28) form a continuous progression.

3. A vehicle lamp (12, 48) according to claim 1, wherein the deflection body (28) defines a groove-like recess (42) in the mirrored mirror surface (22).

4. A vehicle lamp (12, 48) according to claim 1, wherein the deflection body (28) defines a web-like elevation (40) in the mirrored mirror surface (22).

5. A vehicle lamp (12, 48) according to claim 1, wherein the mirrored mirror surface (22) defines a reflector wall (52) of the vehicle lamp (12, 48).

6. A vehicle lamp (12, 48) according to claim 1, wherein the mirrored mirror surface (22) defines a cover element of the vehicle lamp (12, 48).

7. A vehicle lamp (12, 48) according to claim 1, wherein the mirrored mirror surface (22) defines a tube surface of the vehicle lamp (12, 48).

8. A vehicle lamp (12, 48) according to claim 6, wherein light from the deflection body (28) is deflected through an opening in the cover element.

9. A vehicle lamp (12, 48) according to claim 1, wherein a longitudinal extension of the deflection body (28) defines at least one of at least one of a straight- and bent-curve progression and a curve progression following a predetermined curve.

10. A vehicle lamp (12, 48) according to claim 9, wherein the deflection body (28) defines a differing height profile along the longitudinal extension.

11. A vehicle lamp (12, 48) according to claim 1, wherein the deflection body (28) is inclined at an angular range “β” of between about 0 and about 45°.

12. A vehicle lamp (12, 48) according to claim 1, wherein the deflection body (28) extends substantially vertically to the three-dimensional surface (38) of the mirrored mirror surface (22).

13. A vehicle lamp (12, 48) according to claim 1, wherein light can be deflected at least one of substantially horizontally at an angular range of between about 45° forward and about 30° backward in relation to a plane situated substantially vertically to a longitudinal axis of the vehicle and running through the vehicle lamp (12, 48) and substantially vertically at an angular range of between about 10° upward and about 10° downward in relation to a plane situated substantially horizontally to the longitudinal axis and running through the vehicle lamp (12, 48).

14. A vehicle lamp (12, 48) according to claim 1, wherein light can be reflected at least one of substantially horizontally at an angular range of between about 45° to an interior of the vehicle and about 80° to an exterior of the vehicle in relation to a plane running substantially parallel with a longitudinal axis of the vehicle and substantially vertically through the vehicle lamp (12, 48) and substantially vertically at an angular range of between about 15° upward and about 15° downward in relation to a plane running substantially horizontally through the vehicle lamp (12, 48).
